(19) United States
(12) Patent Application Publication
(10) Pub. No.: US 2008/0288276 A1
(43) Pub. Date: Nov. 20, 2008

(54) Method, Process and System for Survey Data Acquisition and Analysis

(75) Inventor: Richard D. Harris, Greensburg, PA (US)

Correspondence Address: THE WEBB LAW FIRM, P.C., 700 KOPPERS BUILDING, 436 SEVENTH AVENUE, PITTSBURGH, PA, 15219, US

(73) Assignee: XENOSURVEY, INC., Greensburg, PA (US)

(21) Appl. No.: 12/122,930

(22) Filed: May 19, 2008

Related U.S. Application Data
(60) Provisional application No. 60/930,813, filed on May 18, 2007.

(51) Int. Cl. G06Q 10/00

(52) U.S. Cl. 705/1; 705/7; 705/14

(57) ABSTRACT

A system for survey data acquisition and analysis, including: at least one central processing system, including a storage device, a processing device and a communication device; and at least one portable computing device, including: a display device configured to visually display content to a user, the content comprising at least one survey question; an input device for receiving survey data input by the user in response to the at least one survey question; a processing device for processing the survey data input by the user; and a communication device in communication with the communication device of the at least one central processing system for transmitting or receiving data. The processing device of the at least one central processing system processes survey data received from the at least one portable computing device. Further methods and processes for survey data acquisition and analysis are also disclosed.

### CROSS REFERENCE TO RELATED APPLICATIONS

This application claims the benefit of priority of U.S. Provisional Patent Application Ser. No. 60/930,813, filed May 18, 2007, which is incorporated herein by reference in its entirety.

### BACKGROUND OF THE INVENTION

1. Field of the Invention

The present invention relates generally to methods, processes and systems for acquiring, processing and analyzing survey data and, in particular, to a method, process and system for the real-time collection, storage and processing of survey data, as well as a method and system for analyzing and communicating raw or processed survey data.

2. Description of the Related Art

Surveys are used in a variety of forms, formats, applications and situations where the surveyor desires to obtain survey data from a specified target audience for use in an analytical process. Once obtained, the data is processed and analyzed for use in making certain marketing, business and/or program decisions. For example, such surveys may be used to find out a consumer's thoughts on a product or service, the audience's thoughts on a program or lecture, etc. The purpose of conducting such a survey is to obtain information that can be used by the surveyor (or designee) to make decisions for improving the present state of the product, service, program, lecture, etc.

Presently, there are available various manners and methods for collecting survey data from consumers and other parties. The most typical manner of obtaining survey data is through the use of a “paper” survey or a telephone survey. In the paper survey, the surveyor interacts with the targeted person or, in some instances, the targeted person simply fills out the survey form and provides the completed form to a designated person or collection point. With respect to the telephone survey, the target person is contacted and asked a series of questions over the telephone, and the surveyor records the answers at the surveyor location for use in further analysis. Once the information is collected and annotated, whether in the paper or telephone survey process, the data is analyzed for use in making marketing and other business decisions. One common drawback of the paper or telephone survey methods is that the survey data collected is manually entered (by hand) by the surveyor, which takes considerable time and realizes a significant cost.

Another method of collecting survey data is an “electronic” survey, conducted using some computing device, e.g., the payment device at the point-of-sale, an online survey, etc. However, there are numerous drawbacks to such electronic-based survey systems. For example, existing point-of-sale/service survey systems are limited to the amount of questions that can be asked, due to restraints on the system capabilities and, more importantly, the time required of the consumer to complete a lengthy survey while standing in the payment line. In addition, such existing survey systems do not permit the consumer to provide any handwritten or verbal comments.

Existing Internet-based survey systems also evidence several drawbacks. Such systems normally use web browsers installed on the client/customer machine, and such systems are, therefore, vulnerable to malicious software attacks and similar corruption. Many client/customer computers do not include the appropriate virus protection software, which leads to a breakdown in the quality and integrity of the survey process. Still further, the general distrust of consumers directed to the possible receipt of such malicious software or virus acts as a disincentive to completing the survey in an online environment. In addition, present Internet-based electronic survey technologies are session-based and cannot capture the survey data if the Internet connection is lost or otherwise disrupted.

Additional drawbacks and deficiencies are evident in these prior art survey methods and systems. For example, existing technologies cannot passively and unobtrusively gather the survey data. Further, these existing survey methods do not enhance the sales process, and instead only increase the consumer's frustration. In addition, present survey processes and systems do not allow the survey questions to be modified by the surveyor, instead requiring the software developers or printers to make such modifications, all at a significant time and expense to the surveyor. By relying on the software developer or printer to make the changes, the surveyor often experiences missed opportunities directed to dynamic changes in the surveyor's business process.

While certain Internet-browser-based surveys may allow the customers to type in comments using a keyboard, there are several drawbacks to such a system. First, many customers are not comfortable with typing in a response and, therefore, the field is frequently left empty. Second, such systems do not recognize that certain information about the customer may be gleamed based simply on handwriting analysis, which is unavailable with typewritten text.

Still further, in many instances, existing survey systems require logic to be applied after the survey results are analyzed. Accordingly, certain entities that offer Internet-based survey systems provide access to results as soon as the survey data is entered through the online method. However, the principal (or decision-maker) must still take the time to review the raw survey data to issue any directives and make the appropriate changes in the business model. In addition, existing survey processes cannot automatically issue a directive to effect change based upon any predefined logic. This results in a missed opportunity to utilize the survey process to perform a threshold analysis and issue specified directives to the appropriate implementers in order to effect change based upon this analysis (which may be some pre-defined logic process).

### SUMMARY OF THE INVENTION

It is, therefore, an object of the present invention to provide a method, process and system for survey data acquisition and analysis that overcomes some or all of the drawbacks and deficiencies of the prior art. It is another object of the present invention to provide a method, process and system for survey data acquisition and analysis that allows for dynamic input at the point-of-sale or at an in-store location. It is a further object of the present invention to provide a method, process and system for survey data acquisition and analysis that gathers useful customer information while maintaining the quality and integrity of the survey process. It is a still further object of the present invention to provide a method, process and system for survey data acquisition and analysis that obtains relevant survey data while enhancing the sales process. It is another object of the present invention to provide a method, process and system for survey data acquisition and analysis that allows for modifiable survey questions. It is yet another object of the present invention to provide a method, process and system for survey data acquisition and analysis that is capable of applying some pre-defined logic that permits the automated communication of specified directives and/or notifications to a decision maker or the business location. It is a further object of the present invention to provide a method, process and system for survey data acquisition and analysis that provides communication, e.g., electronic and secure communication, between the point-of-sale (or in-store location) and other important parties and/or systems.

Accordingly, in one embodiment, the present invention is directed to a system for survey data acquisition and analysis. The system includes: at least one central processing system, including: (i) a storage device to obtain and store data; (ii) a processing device to process data; and (iii) a communication device to transmit or receive data; and at least one portable computing device. The portable computing device includes: (i) a display device to visually display content to a user, where the content comprises at least one survey question; (ii) an input device to receive survey data input by the user in response to the at least one survey question; (iii) a processing device to process the survey data input by the user; and (iv) a communication device in communication with the communication device of the at least one central processing system and configured or adapted to transmit or receive data. Further, the communication device transmits at least a portion of the survey data to the at least one central processing system. The processing device of the at least one central processing system processes survey data received from the at least one portable computing device.

In another embodiment, the present invention is directed to a control interface for a survey data acquisition and analysis system. This control interface includes at least one of the following: an account management section to receive, process and display content representative of administration data; a reporting section configured to receive, process and display content representative of at least one of the following: input data, employer data, employee data, identification data, survey data, communication data, contact data, satisfaction data, threshold data, analyzed data, improvement data, suggestion data, reinforcement data, textual data, graphical data or any combination thereof; and a control section to receive, process and display content representative of control data.

In a further embodiment, provided is a system for survey data acquisition and analysis. The system includes at least one portable computing device, including: (i) a display device to visually display content to a user, the content comprising at least one survey question; (ii) an input device to receive survey data input by the user in response to the at least one survey question; (iii) a processing device to process the survey data input by the user; and (iv) a communication device to transmit or receive data, where the communication device is further configured to transmit survey data. Further included is at least one central processing system in communication with the at least one portable computing system and for receiving at least a portion of the survey data input by the user. The at least one central processing system includes a configurable rule set, and at least a portion of the survey data input by the user is applied to the rule set, which generates action data based upon the application. The action data includes at least one of the following: communication data, contact data, employer data, employee data, satisfaction data, threshold data, analyzed data, improvement data, suggestion data, reinforcement data or any combination thereof.

In a still further embodiment, the present invention is directed to a system for survey data acquisition including at least one portable computing device, which includes (i) a display device to visually display content to a user, the content comprising at least one survey question; (ii) an input device to receive survey data input by the user in response to the at least one survey question; (iii) a processing device to process the survey data input by the user; and (iv) a communication device to transmit or receive data, wherein the communication device is further configured to transmit at least a portion of the survey data.

In another embodiment, provided is a method of acquiring survey data from at least one user. This method includes: providing the user with at least one portable computing device at a retail establishment; and obtaining survey data input by the user on the portable computing device.

In yet another embodiment, provided is a method of acquiring and analyzing survey data. This method includes: providing the user with at least one portable computing device at a retail establishment; obtaining survey data input by the user on the portable computing device; analyzing the survey data input by the user; generating action data for use by a specified person affiliated with the retail establishment; and transmitting the action data to the specified person in a viewable format.

These and other features and characteristics of the present invention, as well as the methods of operation and functions of the related elements of structures and the combination of parts and economies of manufacture, will become more apparent upon consideration of the following description with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification, the singular form of “a”, “an”, and “the” include plural referents unless the context clearly dictates otherwise.

### BRIEF DESCRIPTION OF THE DRAWINGS

FIG. 1 is a schematic view of one embodiment of a system for survey data acquisition and analysis according to the principles of the present invention;

FIG. 2 is an exemplary screenshot for use in connection with a function of a portable computing device in a system for survey data acquisition and analysis according to the principles of the present invention;

FIG. 3 is an exemplary screenshot for use in connection with a function of a portable computing device in a system for survey data acquisition and analysis according to the principles of the present invention;

FIG. 4 is an exemplary screenshot for use in connection with a function of a portable computing device in a system for Survey data acquisition and analysis according to the principles of the present invention;

FIG. 5 is an exemplary screenshot for use in connection with a function of a portable computing device in a system for survey data acquisition and analysis according to the principles of the present invention;

FIG. 6 is an exemplary screenshot for use in connection with a function of a portable computing device in a system for survey data acquisition and analysis according to the principles of the present invention;

FIG. 7 is an exemplary screenshot for use in connection with a function of a control interface in a system for survey data acquisition and analysis according to the principles of the present invention;

FIG. 8 is an exemplary screenshot for use in connection with a function of a control interface in a system for survey data acquisition and analysis according to the principles of the present invention;

FIG. 9 is an exemplary screenshot for use in connection with a function of a control interface in a system for survey data acquisition and analysis according to the principles of the present invention;

FIG. 10 is an exemplary screenshot for use in connection with a function of a control interface in a system for survey data acquisition and analysis according to the principles of the present invention;

FIG. 11 is an exemplary screenshot for use in connection with a function of a control interface in a system for survey data acquisition and analysis according to the principles of the present invention;

FIG. 12 is an exemplary screenshot for use in connection with a function of a control interface in a system for survey data acquisition and analysis according to the principles of the present invention;

FIG. 13 is an exemplary screenshot for use in connection with a function of a control interface in a system for survey data acquisition and analysis according to the principles of the present invention;

FIG. 14 is an exemplary screenshot for use in connection with a function of a control interface in a system for survey data acquisition and analysis according to the principles of the present invention;

FIG. 15 is an exemplary screenshot for use in connection with a function of a control interface in a system for survey data acquisition and analysis according to the principles of the present invention;

FIG. 16 is an exemplary screenshot for use in connection with a function of a control interface in a system for survey data acquisition and analysis according to the principles of the present invention;

FIG. 17 is an exemplary screenshot for use in connection with an issued alert in a system for survey data acquisition and analysis according to the principles of the present invention;

FIG. 18 is an exemplary screenshot for use in connection with an issued alert in a system for survey data acquisition and analysis according to the principles of the present invention;

FIG. 19 is an exemplary screenshot for use in connection with an issued alert in a system for survey data acquisition and analysis according to the principles of the present invention;

FIG. 20 is an exemplary screenshot for use in connection with an issued alert in a system for survey data acquisition and analysis according to the principles of the present invention; and

FIG. 21 is a schematic view of another embodiment of a system for survey data acquisition and analysis according to the principles of the present invention.

### DETAILED DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

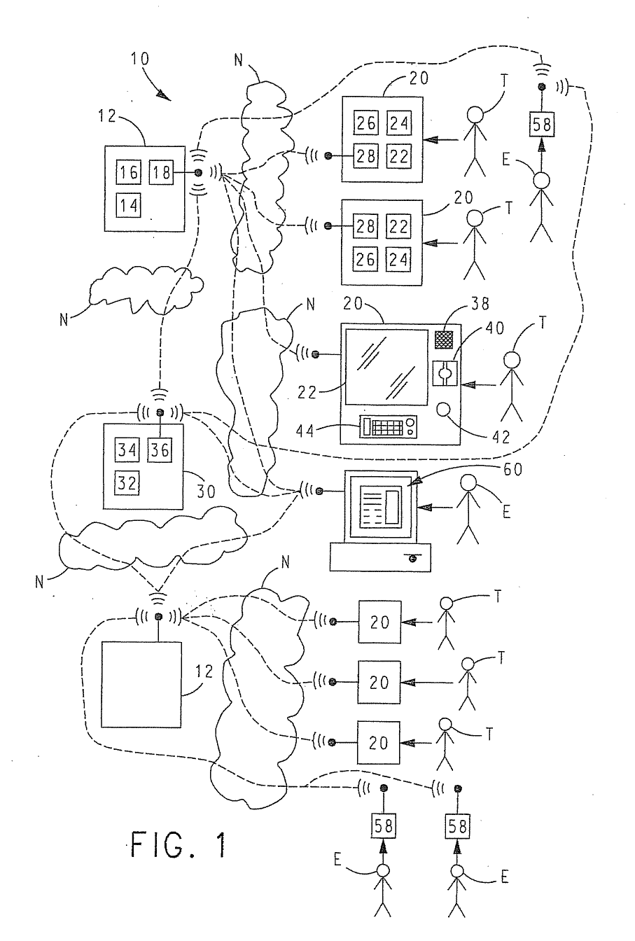

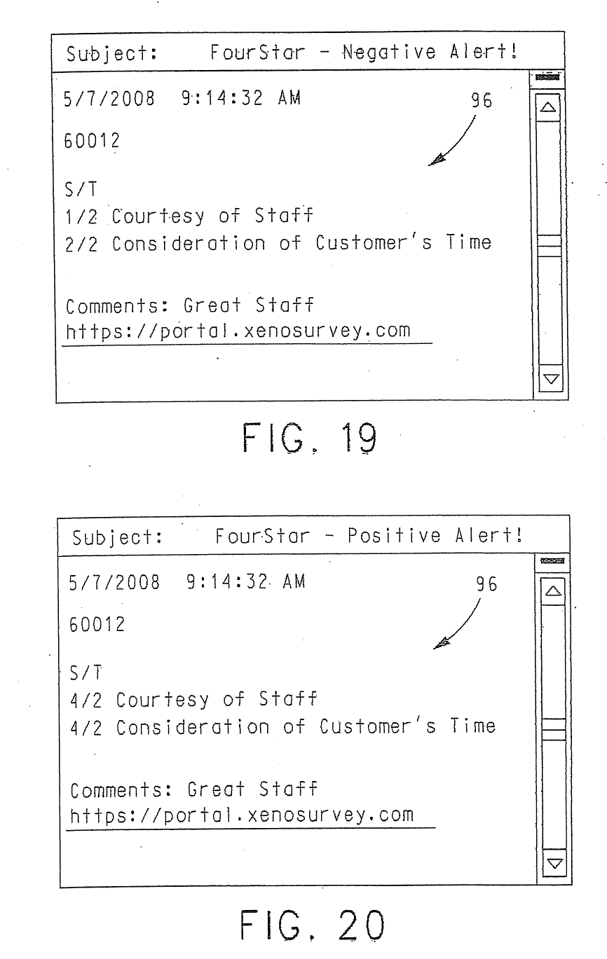

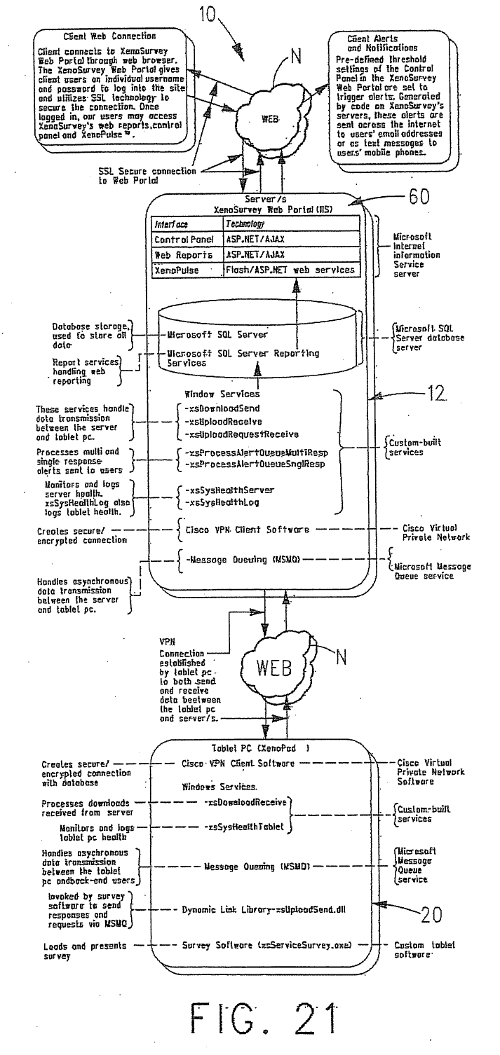

The present invention is directed to a method, process and system 10 for use in obtaining, acquiring, processing and/or analyzing survey data, and exemplary embodiments, screenshots, implementations and variations of portions of this method, process and system 10 are illustrated in FIGS. 1-21. Further, the unique method, process and system 10 of the present invention can be used in a variety of environments, and is preferably used in a networked environment N having multiple, discrete computing devices in communication with each other in a wireless platform. Preferred and non-limiting embodiments of the system 10 of the present invention are illustrated in schematic form in FIGS. 1 and 21. In particular, the system 10 allows for the effective and automated communication and processing of specified data between various parties, including a target T (e.g., a person taking a survey, the customer, the consumer, etc.), an employer, an employee E, an organization, a location, a user, or any other party utilizing the method, process and system 10 of the present invention.

Further, this communication and processing occurs through implementation of the method, process and system 10 on multiple, discrete computing devices, e.g., a portable computing device, a personal computer, a handheld computing device, a notebook computer, a laptop computer, a palm-type computer, a tablet computer, a Personal Digital Assistant (PDA), a cellular phone, a desktop computer, a server or any other computing device capable of performing the required functions and processes, as described herein. In one preferred and non-limiting embodiment, the communication and transmission of data occurs in a wireless form over and through the networked environment N. Accordingly, the raw data and/or processed or analyzed data may be in the form of electronic content that can be obtained, processed, transmitted and/or displayed on the display devices or components of any of these computing devices and systems.

As discussed, one preferred and non-limiting embodiment of the system 10 of the present invention is illustrated in FIG. 1. In this embodiment, the system 10 includes at least one central processing system 12, which includes a variety of components, including a storage device 14 for obtaining and storing data, a processing device 16 for processing data and a communication device 18 for transmitting and/or receiving data. The system 10 further includes at least one (and typically multiple) portable computing devices 20. In one preferred and non-limiting embodiment, these portable computing devices 20 are in the form of portable computers, such as a tablet computer or similar hand-held and lightweight computing device that is easily carried and utilized by a user, such as the target T. The central processing system 12 may be located on-site with or remote from the portable computing devices 20, and, further, the central processing system 12 may be in hardwired or wireless communication with the portable computing devices 20.

The portable computing device 20 also includes various components for effective operation within the system 10 of the present invention. In particular, the portable computing device 20 includes a display device 22 that can visually display content to a user, such as the target T, the employee E, an administrator or other person interacting with the portable computing device 20. Further, this display device 22 is capable of displaying content that includes one (and typically multiple) survey questions presented to the target T. An input device 24 is included and capable of receiving survey data input by the user in response to these presented survey questions, and a processing device 26 processes this survey data input by the user.

The portable computing device 20 also includes a communication device 28 that is in communication with the communication device 18 of the central processing system 12, and this communication device 28 is programmed to transmit at least a portion of the survey data (and any other data-of-interest) to the central processing system 12. Further, the processing device 16 of the central processing system 12 processes and/or analyzes this received survey data for use in facilitating other functions in the system 10 of the present invention.

Accordingly, this survey data may be obtained in a variety of manners and applications, and it should be noted that the presently-invented method, process and system 10 is not limited to any particular manner of survey data collection, processing, analysis or communication. As discussed, a variety of users are envisioned, and this survey data may be acquired or collected from a consumer or user (target T) at the point-of-sale/service, a customer or consumer at the payment area at an in-store location, from a consumer browsing at an in-store location, from an attendee of a lecture, from an attendee of a program, etc. Specifically, the presently-invented method, process and system is equally useful in connection with a variety of parties, where one party desires to ask question of and obtain information from another party.

Still further, the method, process and system 10 of the present invention is configurable to display or present any number of questions or queries seeking responses from the target T, and the raw survey data input and collected can be annotated, processed, analyzed or otherwise reconfigured to provide useful information to the surveyor (or person that has directed that the survey be performed), typically the employee E (or the organization that the employee E works for). Based upon this information, and as discussed in detail hereinafter, appropriate business or similar decisions can be made, and these decisions or directives may be transmitted or communicated to any appropriate party, system or location for implementation. Still further, it is envisioned that the present method, process and system 10 includes the appropriate computer-implemented program instructions for making automated decisions or directives based upon the analyzed survey data, and communicating these automated decisions or directives to the appropriate parties. Of course, any number of variations, functions and features may be used within the context and scope of the present invention.

In one preferred and non-limiting embodiment, the survey data input by the user is in the form of a selection from a plurality of responses (multiple choice), an alphanumeric response, a textual response, a handwritten response, a verbal response, and these responses may include identification data, user data, employer data, employee data, responsive data, etc. The use of the term “survey data” is intended to include any data field that is affiliated with (directly or indirectly) the method, process and system 10 for survey data acquisition and analysis according to the present invention. Still further, the communication device 28 of the portable computing device 20 is programmed or configured to transmit the survey data to the on- or off-site central processing system 12 in dynamic form, real-time form, batch form, periodically, contemporaneously, in a raw format, in a translated format, in an analyzed format, etc. Accordingly, the processing and/or analysis of the survey data input by the user (target T) may be implemented on the processing device 26 of the portable computing device 20, or alternatively, by the central processing system 12 (or, as discussed hereinafter, some other remote processing system).

As discussed, it is envisioned that multiple computing devices 20 are used, often simultaneously, with multiple targets T (e.g., customers or consumers) at each location. Further, each of these portable computing devices 20 are in communication with the central processing system 12, which is normally situated remotely from these computing devices 20. For example, the central processing system 12 may be situated on-site at a different location (perhaps in a back office or other secure location on the site), or in a more remote location off-site, e.g., a central headquarters or other centralized location. Accordingly, in a further preferred and non-limiting embodiment, a main processing system 30 may be used and includes a storage device 32, processing device 34 and communication device 36, which operate and function as discussed above in connection with the central processing system 12. Further, in this embodiment, multiple central processing systems 12 (at different locations) are in communication with the communication device 36 of the main processing system 30. Alternatively, the main processing system 30 may be in communication with and collect data directly from the individual portable computing devices 20 at the various locations. Any such variation and relationship between the main processing system 30, central processing system 12 and portable computing devices 20 can be used to implement the method, process and system 10 of the present invention by permitting appropriate data flow and collection.

For example, the central processing system 12 may be positioned at some remote, secure location, and the portable computing devices 20 at the local area, e.g., in the store, at the dealership, etc., may be in communication with a router or other communications device. This router would transmit survey and other data to the communications device 18 of the central processing system 12 in real-time, dynamically, in batch form, etc. Any number of variations in the communications and connections between the portable computing devices 20 and the central processing system 12 is envisioned. Further, the communication may be through a local area network, a wide area network, a WiFi network, a satellite network, a radio network, the Internet, etc.

In another preferred and non-limiting embodiment, and in order to capture all of the appropriate survey data from the target T, and to perform other various functions, the portable computing device 20 may also include a microphone 38 to capture verbal responses from the target T, a magnetic strip reader/writer 40 to permit payment and other interactions (as described hereinafter), a camera 42 to obtain visual (video or still-shots) data, a keyboard 44 for obtaining keyed entry of data, etc. Any of these devices, including the display device 22, the microphone 38, the magnetic strip reader/writer 40, the camera 42 and the keyboard 44 may serve as a portion of or part of the overall input device 24 for obtaining appropriate data input from the target T. Accordingly, the portable computing device 20 includes all necessary hardware and programmable instructions to effectively interface and communicate between these components to obtain, process and transmit the appropriate data to the central processing system 12 and/or the main processing system 30.

As discussed, and in one preferred and non-limiting embodiment, the portable computing device 20 is a tablet computer, and the display device 22 and input device 24 are in the form of a computer screen configured to permit interaction with a stylus. Using this stylus, the target T may selectively input data, whether by touching the screen and selecting appropriate portions on the screen, or by providing handwritten comments or other data in specified areas. Therefore, in this embodiment, pen-based computing is used in connection with the portable computing device 20.

In another preferred and non-limiting embodiment, the portable computing device 20 is provided to the target T at or near a cashier's area in a service department. This portable computing device 20 is in wireless communication with a router, which transmits the survey and other data input provided by the portable computing device 20 through the networked environment N to either the central processing system 12 (which may be located on- or off-site) and/or to the main processing system 30, also in an on- or off-site location. In this embodiment, the networked environment N includes virtual private network internet protocol security ports open through the local network firewall for appropriate data communication.

In a further preferred and non-limiting embodiment, the consumer or target T is provided with the portable computing device 20, which is capable of displaying survey and other electronic content. In one embodiment, the survey method, process and system 10 is designed for use in connection with the automotive industry where the consumer or target T is provided with the portable computing device 20 with appropriate programmable instructions thereon for use at some point during the sales transaction at the dealership. For example, the person may be provided with this portable computing device 20 after negotiating the final sale, during the negotiation process and/or any other point in the sales process where the customer experiences “downtime.” While discussed in some instances hereinafter in connection with the automotive industry, the presently-invented method, process and system 10 can be used in connection with any applicable industry, whether a provider of goods and/or services, as well as with lectures, programs and other gatherings that have an audience.

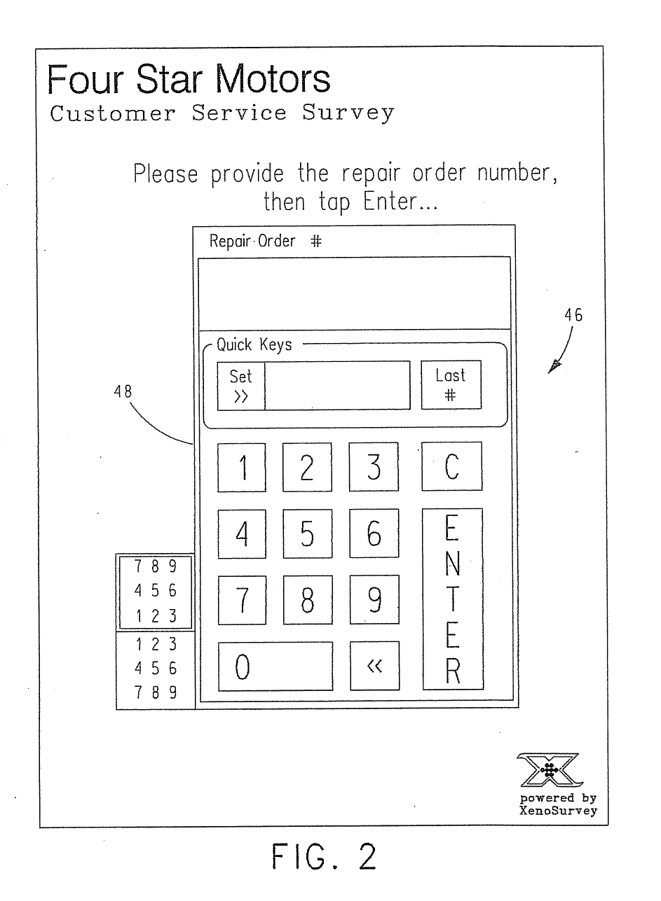

On the portable computing device 20, either the employee E or the target T provides appropriate identification information in order to start the survey process. For example, as illustrated in FIG. 2, a number pad 46 can be provided, and in this case, some identification number that associates the survey with the target T is entered. For example, a repair order number or similar identification can be used. This repair order number can be entered by the employee E or the target T, and further, this repair order number can be preset, where the first several digits of the repair order number are provided. If sequential repair order numbers are used at the location, the employee E may simply click the sequence and finish entering the last digit or two of the repair order number to save time. The use of this preset repair order number can be configured and implemented using various assigned selectable buttons 48 displayed on the display device 22 of the portable computing device 20. Another time-saving feature that may be provided is a selectable button 48 that immediately supplies the last repair order number. When this selectable button 48 is selected, the repair order number entered for the previous survey appears in the repair order number box.

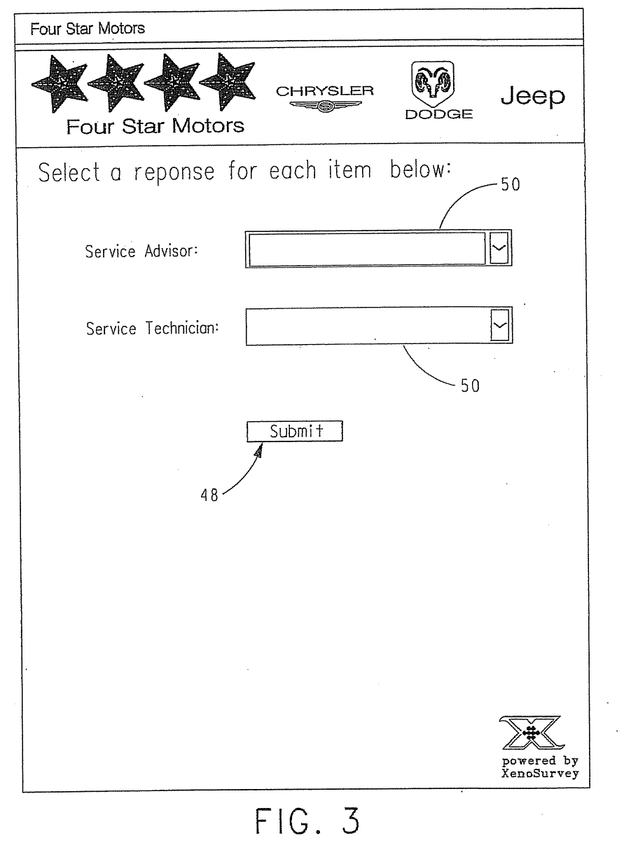

Next, and as illustrated in FIG. 3, either the employee E or the target T may enter the identification of the employee E that he or she is dealing with, such as a service advisor or a service technician. It is envisioned that the names of these employees E may be provided in a drop-down menu 50. It is further envisioned that this initial setup screen and process is displayed for use by the sales associate or employee E to initiate the use of the survey system with a customer. For example, the sales associate may enter directly any information onto the screen (such as in the form of an interactive interface), and may also use the drop-down menus 50, boxes, selectable buttons 48, direct-entry boxes or other selectable content on the display device 22. Accordingly, the sales representative may provide their name, the customer name, as well as the vehicle that the customer or target T is interested in. Regardless, this information provides basic identification of the employee E (and, in some instances, the target T), which, after submission, allows the process or survey to begin.

Prior to displaying the survey, a script or other electronic content may be displayed to the target T. This script may include guidelines for engaging in the survey process, or provide other messages from the employer (or employee E) to the target T. Of course, it is envisioned that the target T may opt out of the survey, but, as discussed hereinafter, would not then be provided with possible additional incentives for survey completion.

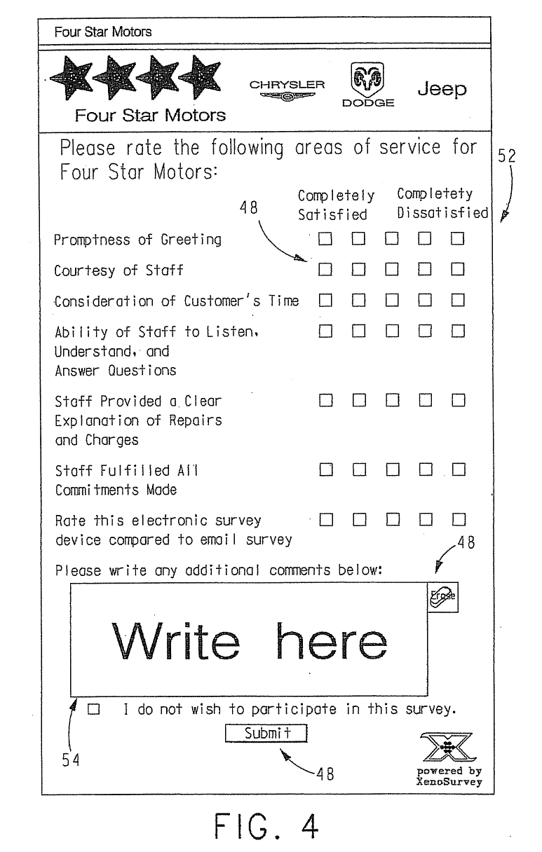

As illustrated in FIG. 4, a survey interface 52 is then provided to the target T. Any number, type, quantity or manner of survey data may be collected within the system 10 at this survey interface 52. In this example, the target T is asked to provide information regarding the dealership and the sales person. Of course, other questions may be provided, and these questions may be configured by the owner of the system 10, an administrator, a programmer, etc. For example, the target T may be asked to input certain “personal” information regarding children, family and other similar data. When satisfied with the selections and answers, the user activates a “submit” button, or selectable button 48. Further, as illustrated in FIG. 4, a handwritten input area 54 is provided for use in capturing handwritten survey data input by the target T. The handwritten data input in this area 54 may be manipulated and/or erased, as desired by the target T. As discussed hereinafter, additional information may be gleaned from a person's handwriting that is not capable of being obtained through simple selection of the selectable buttons 48 on the survey interface 52. Also, as discussed, a verbal response may be input via the microphone 38, and a visual response may be input through the camera 42. Still further, and if desired, additional input may be provided to the portable computing device 20 through the keyboard 44.

One incentive for completion of the survey by the target T is the provision of the user with the ability to browse the Internet in a controlled environment. Accordingly, selectively browseable web data may be displayed to the target T and be limited according to a predefined rule set. For example, various predefined categories of interest may be available to the customer, and advertising and other electronic content may be displayed simultaneously. For example, icons may be displayed and would open a predefined website or web page based upon the category of interest. However, it is envisioned that any electronic content may be displayed to the user, e.g., electronic documents, presentations or other electronic content relative to the user's selection. As discussed, this browsing function may be limited and nested within the customer application portion of the system 10. In addition, the amount of time spent on each category and other relevant selection data may be tracked and analyzed to provide additional demographic information about the customer's interest.

Providing the target T (customer) with controlled web browsing would encourage them to effectively complete the survey during a long waiting period, such that the user may then browse the Internet during his or her wait. Of course, other incentives may be offered to the user to complete the survey, such as the provision of paper coupons, electronic coupons, gift certificates, discounts, vouchers, electronic incentives, paper incentives, etc., whether in paper or in electronic form. In addition, the user may be provided with coupons, gift certificates, discounts, etc. for use in various businesses that may be associated with, affiliated with or otherwise in a contract with the surveyor (employer), which, in one example, is the dealership. For example, the person may be provided with a discount to a restaurant near the dealership, as well as directions or other instructions regarding how to use the coupon or locate the restaurant. In this manner, both the dealership, as well as the restaurant, would benefit from the implementation of the system 10. As set forth above, and in one preferred and non-limiting embodiment, the user's browsing experience is controlled, as well as tracked, by the system 10. As with the data input at the handwritten input area 54, the target's browsing habits can be appropriately tracked and analyzed for use of providing the customer with a better experience.

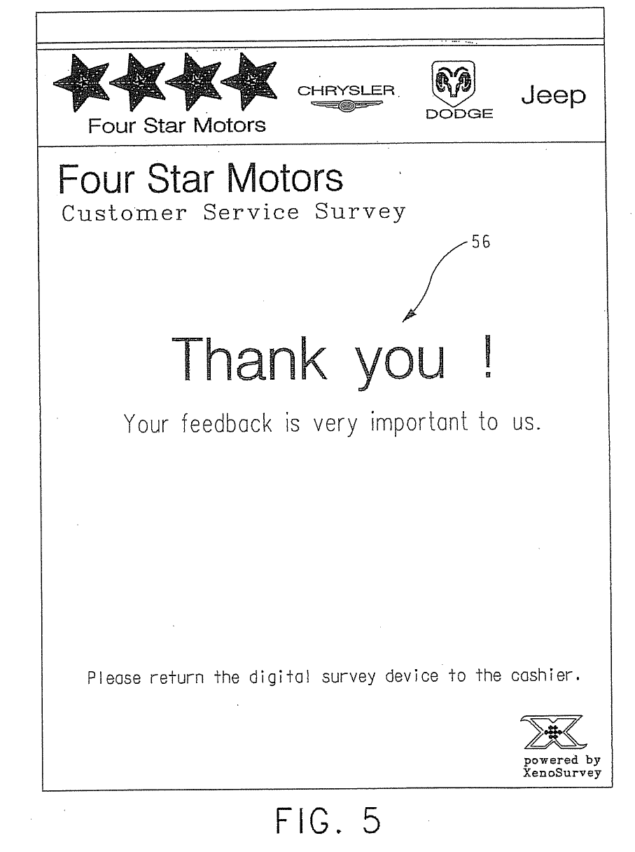

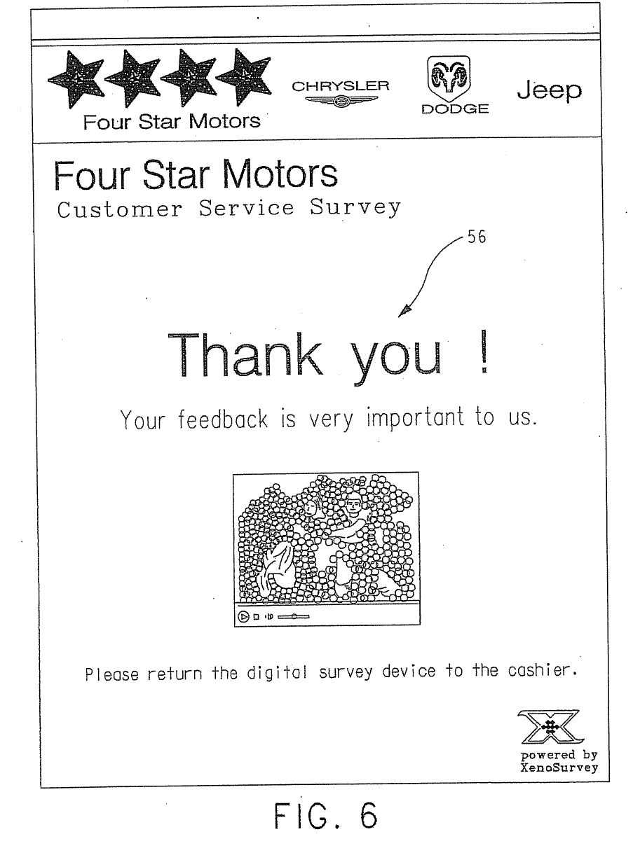

FIGS. 5 and 6 illustrate various end screens 56 displayed to the target T, which allows the service provider to communicate his or her appreciation to the customer. FIG. 5 illustrates a strictly textual end screen 56, while FIG. 6 illustrates a short video that is displayed to the user. Normally, it is at this screen 56 that the target T is requested to return the portable computing device 20 to the employee E. Of course, the above-discussed incentives may be provided to the customer or consumer at this point or in connection with this end screen 56.

All of this survey and other data input by the target T (or the employee E) is captured, processed and transmitted to the central processing system 12 and/or the main processing system 30. Further, and as discussed above, the system 10 is capable of capturing handwritten text, which would allow the system 10 to capture comments and user information that would otherwise be unavailable in a set survey form in an electronic environment. In addition, oral or verbal input, as well as video input, may also be provided. With respect to the handwritten input area 54, the target T may write his or her comments in the appropriate area, and this electronic, handwritten data is captured and translated. For example, the handwritten data may be digitally captured in a database, e.g., as a raster file, and additional analysis may be performed later using known handwriting analytical tools. Further, the portable computing device 20 may translate the verbal or video input into an appropriate digital and/or textual form.

In addition, the handwritten text may be captured as raw stroke data, which may include the pressure and speed of each stroke, and reconstructed as raster data when necessary to do so on display or print functions. Such stroke data allows for stronger analysis based on the attribute data. Another significant benefit of capturing raw stroke data is that it requires less storage space, and further, transmitting raster data over the networked environment N, e.g., the Internet, even as monochrome bitmaps, is not as efficient as transmitting the raw stroke data. For example, while a raster data file may require about 60K or more (depending on the actual handwritten response), the raw stroke data is only 2-4K in size.

In another preferred and non-limiting embodiment, the amount of time between the responses to each question is monitored and recorded. This may provide additional data for analysis regarding the target T behavior, e.g., if a person checks each box in a rapid succession, it may indicate the amount of thought went into the survey. Further, this analysis may lead to information regarding what threshold indicates a less or more meaningful response.

It is further envisioned that certain additional functions may be performed directly on the portable computing device 20. For example, the employee E may interact with the portable computing device 20 in a variety of manners not available to the target T. For example, the employee E, or some administrator, may display survey session statistics, which would indicate the number of surveys submitted during the current session. It may also display how many surveys were declined by the customers, which may be compared to the number of repair order numbers in a given period to ensure that all customers are given surveys. The employee E may also search for any updates to the survey process or programmable instructions for implementing the system 10 on the portable computing device 20, such as when survey questions are changed or when functional updates are available. Further, the employee E or appropriate information technology personnel may exit from the limited and contained survey process on the portable computing device 20 in order to perform appropriate maintenance and other base level systems operations on the device 20.

Once the raw survey data is obtained, this data may be viewed or used by the surveyor or employer (or designee) in this unanalyzed or raw form. However, in most cases, this raw data is processed and analyzed in order to provide immediately useful results. For example, the number of surveys submitted may be tracked and certain results automatically provided to the surveyor at the in-store level. For example, customer satisfaction data may be provided in real-time in the form of percentages, e.g., a customer satisfaction index (CSI), or other numerical format. Again, these percentages or numbers may be calculated and dynamically communicated and displayed in real-time, and may be used to generate automatic notifications based upon the interactive control panel application, as discussed hereinafter.

Accordingly, some configurable rule set is applied, and at least a portion of the survey data input by the target T is applied to this rule set, which generates action data based upon the application. The action data may include communication data, contact data, employer data, employee data, satisfaction data, threshold data, analyzed data, improvement data, suggestion data, reinforcement data, predefined messages, configurable messages, etc. Further, this generated action data may be automatically and electronically communicated to a specified contact point based upon the application. For example, this specified contact point may be an organization, a location, an employer, an employee, a user, a portable computing device 20, a personal computer, a cellular telephone, a personal digit system, a laptop computer, a palmtop computer, a notebook computer, a server, a tablet computer, etc. As discussed in more detail hereinafter, and as illustrated in schematic form in FIG. 1, this action data (such as in the form of alerts, textual information, messages, etc.) may be transmitted to the employee's E cellular phone, personal digit assistant, etc.

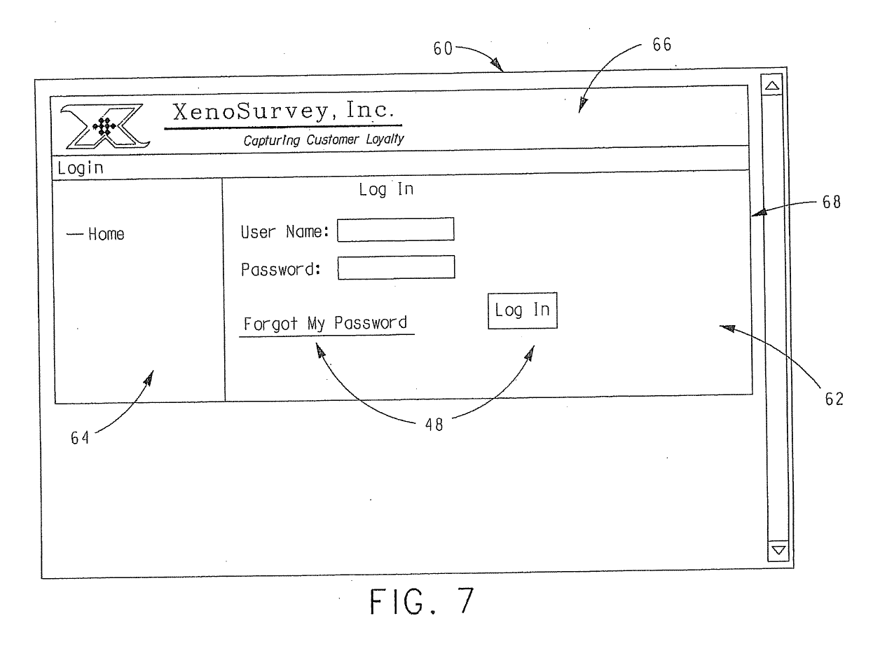

In another preferred and non-limiting embodiment, and as illustrated in FIGS. 7-16, the system 10 includes a control interface 60, which is accessible by the employee E or other person affiliated with the organization or employer conducting the survey, e.g., an administrator, an IT employee, a manager, etc. This control interface 60 may be in the form of a client portal website available over the Internet, and interaction would begin at a login screen 62, where the user would input a user name and password to access the control interface 60. The general form and format of the various screens discussed hereinafter include a navigation section 64, a header section 66 and a content section 68. In the navigation section 64, a menu is provided for managing the various aspects of the control interface 60. Normally, this navigation section 64 will provide a menu beneath the identification of the user, and hovering the cursor over the individual navigation menu items will reveal the selections that will launch other pages within the portal (control interface 60). The header section 66 may include certain identification information, such as the owner or implementer of the system 10, as well as a login/logout link, and a navigation trail showing what page is currently being viewed. The content section 68 contains information and data specific to the current menu selection, such as survey data, report output, data entry forms, general information, etc.

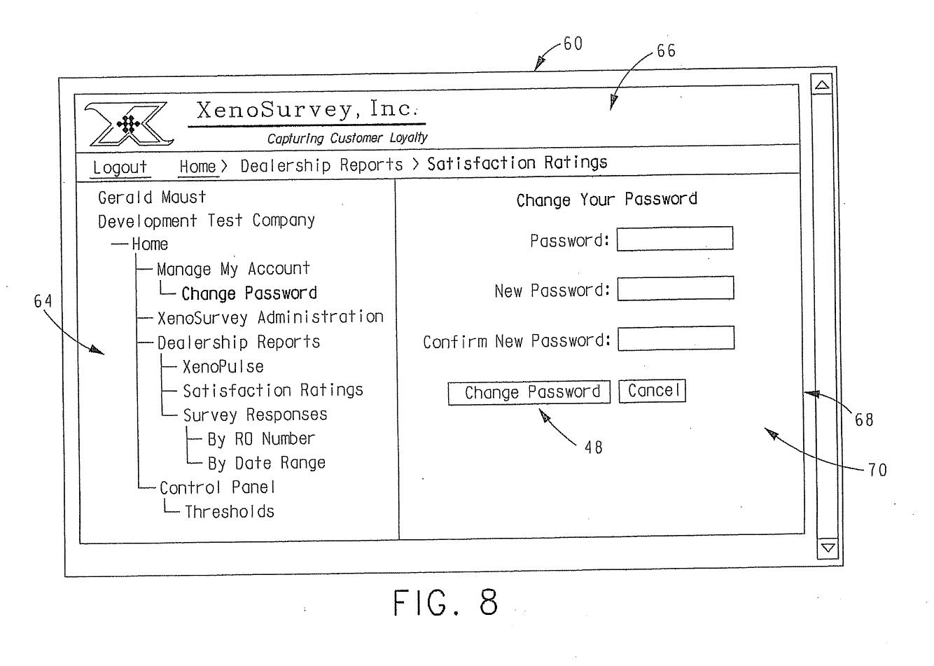

In FIG. 8, an account management section 70 is illustrated. It is often recommended that the user change the password that has been initially provided to one only known by that user. In this account management section 70, the individual use may change the password, as is well known in the art.

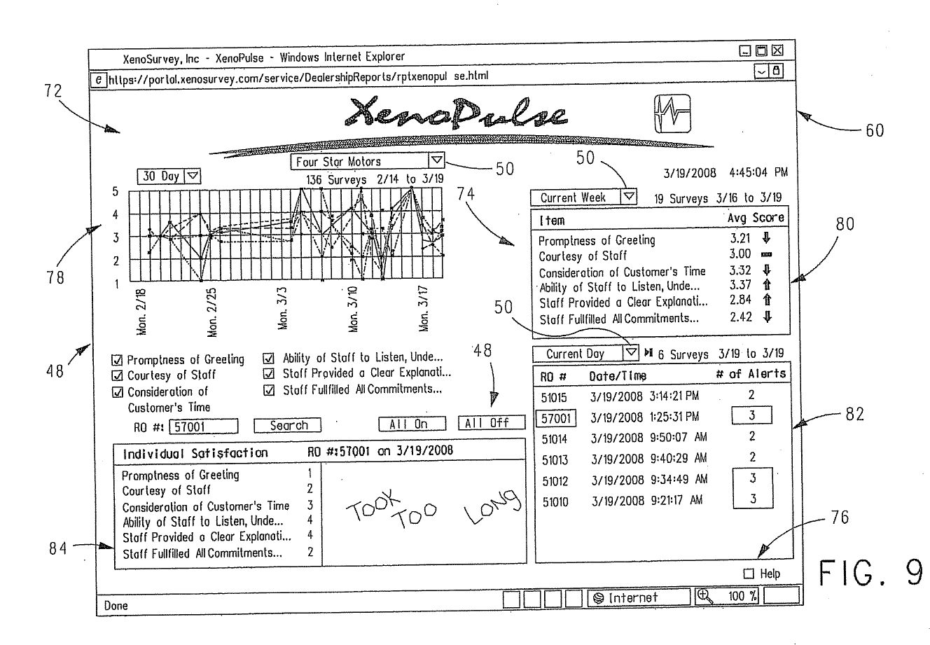

As illustrated in FIG. 9, and in one preferred and non-limiting embodiment, the control interface 60 includes a reporting section 72, which displays various raw and/or analyzed survey data in textual and/or graphical form. For example, this reporting section 72 is capable of receiving, processing and displaying content representative of input data, employer data, employee data, identification data, survey data, communication data, contact data, satisfaction data, threshold data, analyzed data, improvement data, suggestion data, reinforcement data, textual data, graphical data, configurable rules, etc.

One exemplary embodiment of an arrangement of such data is illustrated in FIG. 9, which includes, initially, an employer identification section 74. This ensures that only those employers (or employees thereof) with appropriate permissions may view the information and data regarding any particular entity. This would permit the user to change the specific location, e.g., dealership, they wish to view by changing the selection in a drop-down menu 50. Of course, this drop-down menu 50 would not be visible for those users who have permission to view only one entity or dealership. A help section 76 is also provided, and when selected, displays content appropriate to answer any queries submitted by the user. Of course, this “help” may be in the form of frequently asked questions, an index of information, etc.

As also seen in the exemplary embodiment of FIG. 9, a response chart section 78 may be provided and plot question responses over a selected time span. Each question may be represented by a uniquely-colored line, which may be turned “on” or “off” by clicking on the correspondingly-colored check-box located below the graph. All questions may be turned “on” or “off” by clicking the “all on” or “all off” buttons, respectively. In addition, the time period is selectable by the user for displaying the trends and answers over any desired period of time. Further, the total amount of surveys in this time period is also displayed. For example, these time span options may be in the form of “day,” “7 day,” “30 day,” “year-to-date,”etc. When the “day” time span is chosen, the individual survey scores for the current day are plotted, and the “7 day” and “30 day” options will plot the average daily score for each survey question. The “year-to-date” option plots the weekly average score for each survey question. Both direct and average score plots are adjusted in real-time as new surveys are submitted. In addition, the actual dates for that particular and selected time span are shown near where the total number of surveys is displayed. Still further, the time period may be manually selected and set by the user through a direct-entry box, a selectable calendar, etc.

The reporting section 72 may also include a score section 80, which displays current average response scores over the selected time span. Arrows or other indicators may be provided near each score and used to reflect whether the most recent question response is higher than, lower than, or equal to the overall average. The information and data in this score section 80 may also be selected according to a specified date range, which is used to calculate the average score and trend for each question. Each option may be based on the current day and time. In one embodiment, the “current day” and “current week” time spans will not include data from the previous day or week, respectively. The “month-to-date” and “year-to-date” options will include data from the beginning of the month or year to the current date and time. Again, all scores and information and data in this area are updated dynamically and in real-time as new surveys are submitted. Further, the total number of surveys recorded during the time span that is defined, as well as the specific dates of the time span, is displayed in this score section 80. Any number of and manner of graphical or visual representations of the survey data may be displayed in this reporting section 72.

As further illustrated in FIG. 9, the reporting section 72 may include an alert section 82. In this alert section 82, unique events are identified, specifically events that cause an alert, whether positive or negative. In the exemplary embodiment of FIG. 9, the alerts are associated with a specific repair order number (which is associated with a specific employee E and/or target T), and it is identified that a specific repair order number has triggered at least one alert during the specified time span. The date and time of the alert is associated with the specific repair order number, and the number of questions that scored below the employer-defined threshold for that specific survey question is displayed. For example, a number “6” in this area would indicate that the customer gave 6 negative responses on the survey, i.e., responses that are below the defined threshold. Other indicators may be used to provide information to the user, such as, in this example, repair order numbers that trigger five or more alerts are highlighted in red, repair order numbers that trigger three or four alerts are highlighted in yellow, and repair order numbers that trigger one or two alerts are left uncolored.

Of course, this is an option that is activatable and configurable by the user (or administrator), as are all of the sections in one preferred and non-limiting embodiment of the control interface 60. Individual survey results for a specific repair order number may be viewed through the alert section 82, and the results will be displayed in an individual survey section 84. In addition, in the alert section 82, a drop-down menu 50 is provided for specifying the number of days to search for alerts, and the total number of alerts recorded during the time span that is defined are also displayed. The actual dates for that time span are shown in the alert window to the right of the number of surveys recorded.

As also illustrated in the exemplary embodiment of FIG. 9, individual survey results and similar data are displayable in the individual survey section 84. For example, this individual survey section 84 may be used to display survey results associated with a specific repair order number. Users may also search for a specific repair order number, and the resulting content will indicate the individual scores for that survey, and may also provide the time of the survey, the date of the survey and any handwritten comments entered in the handwritten in put area 54. Further, this individual survey section 84 would display any translated verbal or visual responses provided at the portable computing device 20.

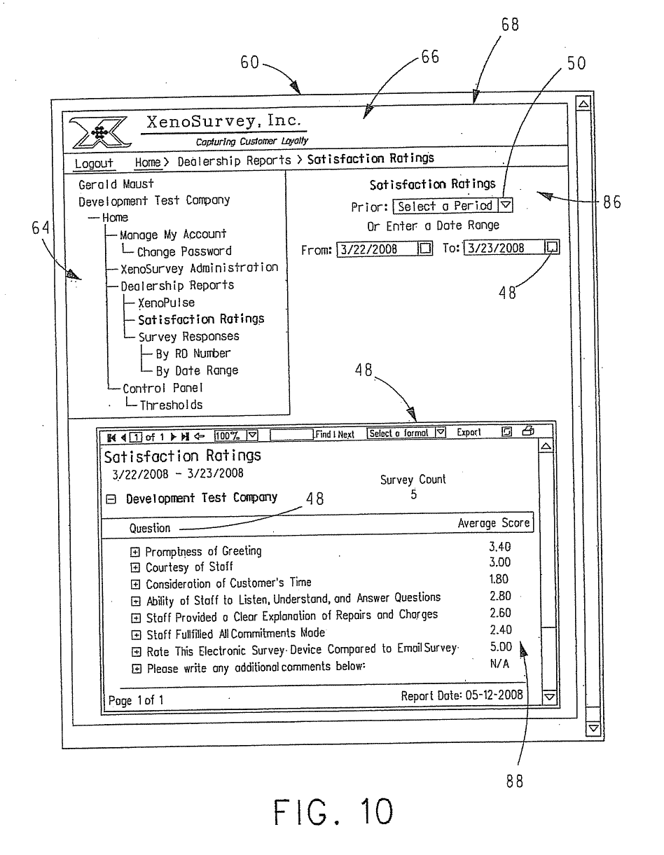

In another embodiment, and as illustrated in FIGS. 10-14, a ratings section 86 may be provided, which allows the user to view customer survey responses in real-time. In this ratings section 86, similar data to that described above in connection with the reporting section 72 may be configurable, arranged and provided to the user as electronic content. Further, in this ratings section 86, summary data pertaining to each question that appears on the survey may be presented in tabular or similar format, allowing the user to locate and analyze individual survey responses, including handwritten responses provided by the customer. Various reports 88 may be displayed to the user in this ratings section 86. For example, specific time periods or date ranges may be chosen, and the use of a calendar icon may display a pop-up calendar where specific individual dates or date ranges may be chosen.

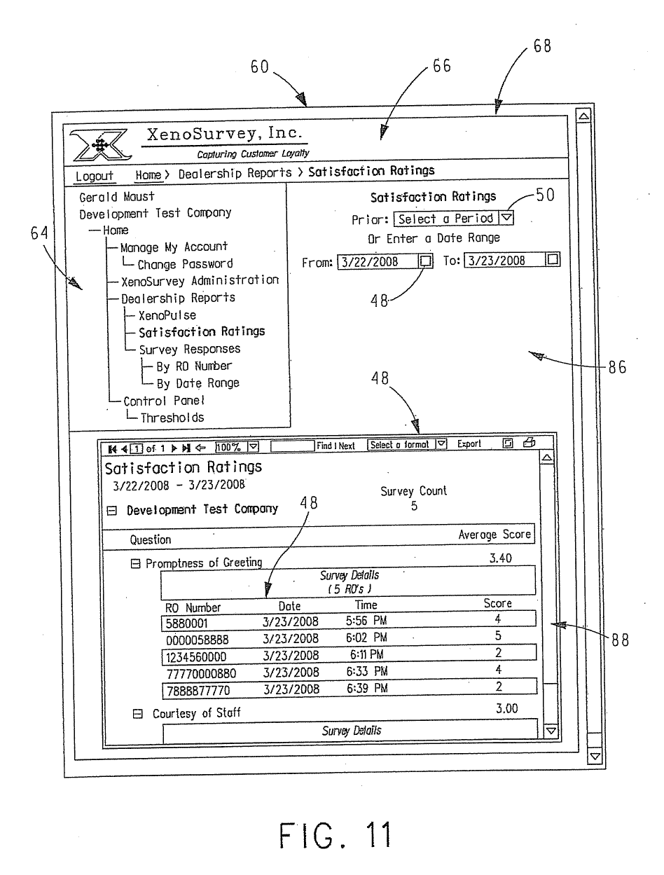

As illustrated in the report 88 in FIG. 10, the user has selected to see the survey data and satisfaction ratings for March 22^{nd} and March 23^{rd}. In this time period, five surveys were collected, and the question and average score is displayed. In FIG. 11, wherein the same date range was selected, the user has activated the “+” button next to the “promptness of greeting” question, which provides additional and detailed information regarding this specific question. In particular, the specific repair order number, date, time and score for each of the five surveys is included in this report 88 (FIG. 11). In addition, by activating the repair order number in the form of a selectable button 48, the user is directed to the individual survey responses for that repair order number through a link. Accordingly, the user may easily navigate through the reports 88 using the “+” and “−” selectable buttons 48.

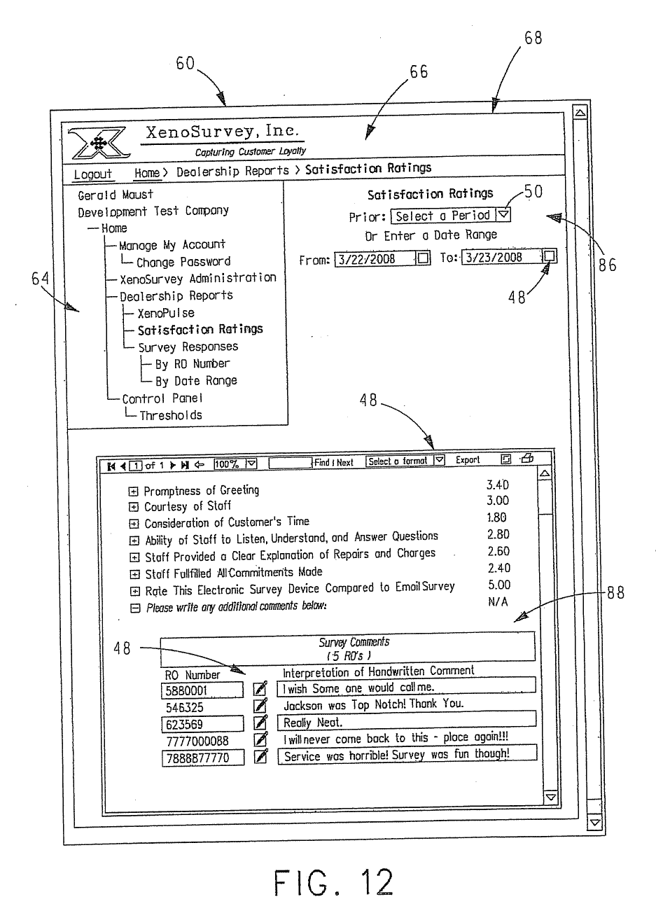

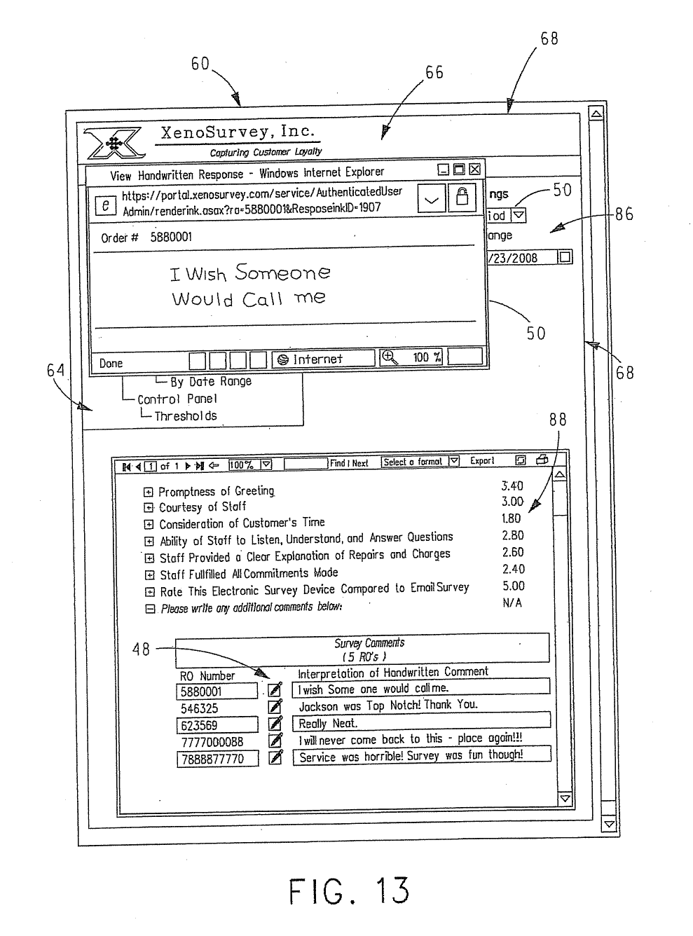

As illustrated in FIG. 12, where the same date range is selected, the user may view the various comments directly input, such as through the handwritten input area 54, by the target T. As with the questions discussed above, this report 88 associates specific interpretations of the handwritten comment with the appropriate and linked repair order number. By selecting a “pencil” selectable button 48, the user may view the actual handwritten comment in a pop-up box 90. See FIG. 13.

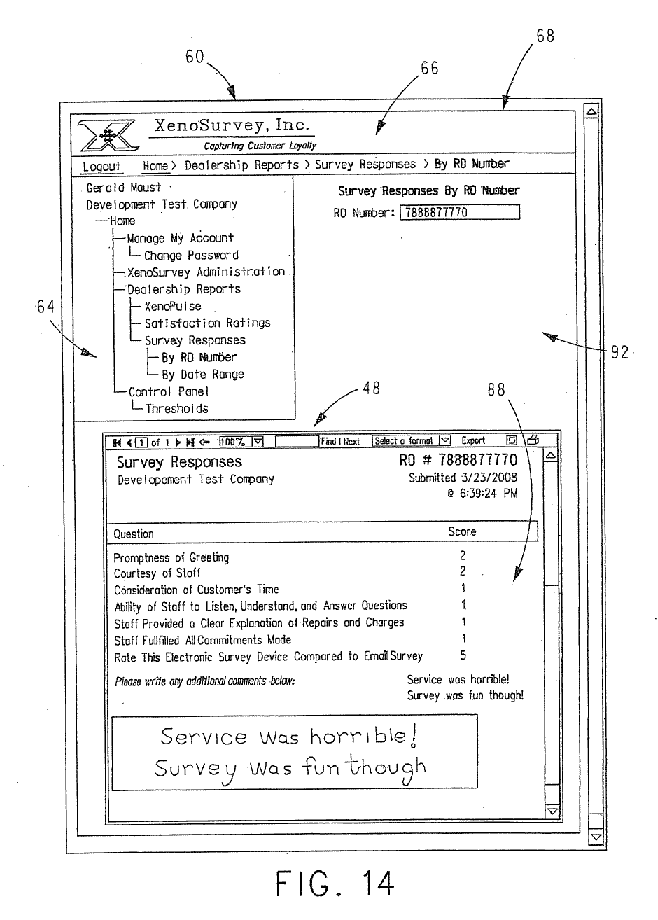

The control interface 60 also includes a survey response section 92 that displays the survey data input by the target T for a specific repair order number, as illustrated in FIG. 14. Of course, it is also envisioned that the survey responses for a specified date range may also be displayed. This allows the user to see the complete and responsive survey data input by the target T according to the specified target T (associated via the repair order number), or according to a selected date range.

Navigating through the reports 88 in the ratings section 86 and survey response section 92 may be accomplished in a variety of manners. However, various selectable buttons 48, drop-down menus 50, direct-entry boxes, etc. can be used to permit the user to go to the first page, go to the previous page, display a specified page, go to the next page, go to the last page, zoom in on the content, search for a specific text within the report 88, export the report 88 in a specified format, e.g., XML, CSV, TIFF, PDF, web archive, Excel, etc., refresh the contents of the report 88, print the report 88, etc.

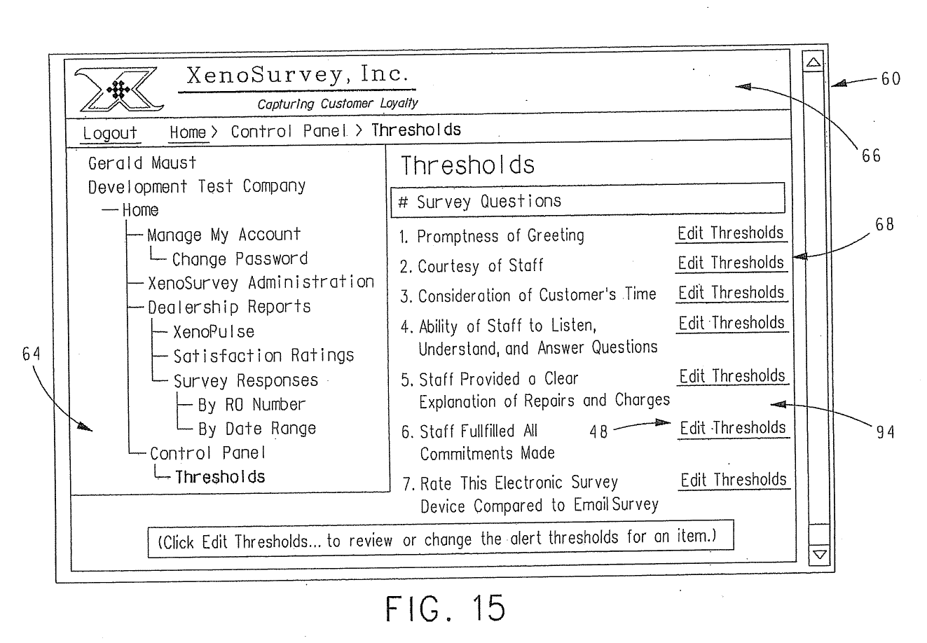

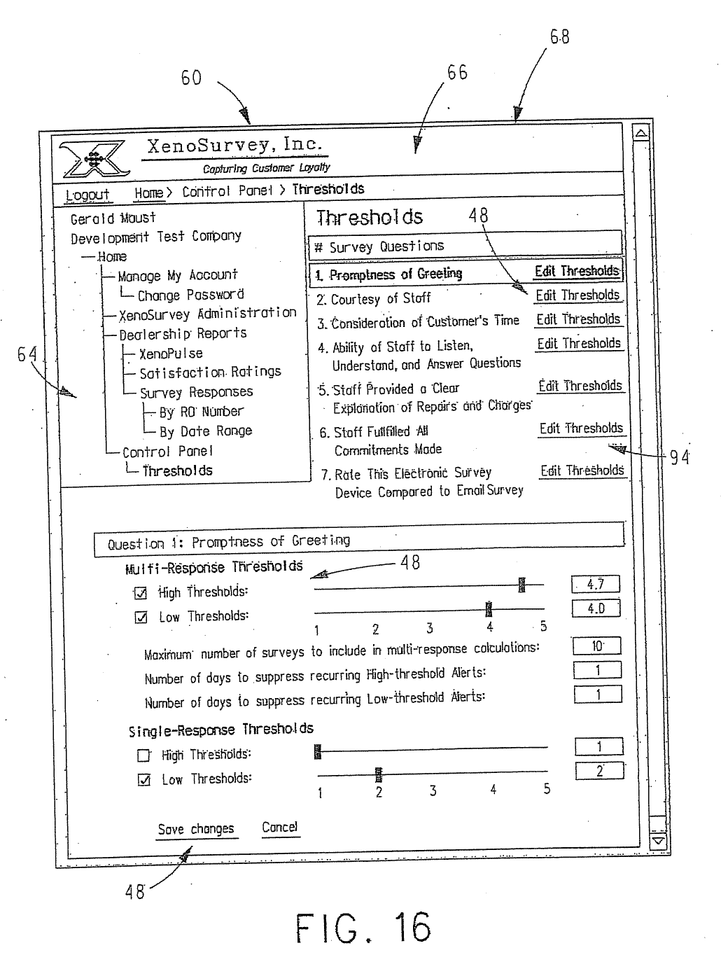

As illustrated in FIGS. 15 and 16, the control interface 60 may also include a control section 94, where the user may define, configure and manage the thresholds set for providing alerts 96 or other messages to the employees E at a specified location. As seen in FIG. 15, the survey questions are provided, and the user may select to edit the thresholds, which leads to the screen illustrated in FIG. 16.

In the exemplary embodiment of FIG. 16, the user is editing the information for the “promptness of greeting” question. In particular, a high threshold and a low threshold are selected, whereby a “positive” alert 96 is sent indicating this positive performance when a specified number of surveys (on average) exceed the high threshold. Similarly, a “negative” alert 96 is sent when the chosen number of surveys (on average) falls below the low threshold. The user may select the number of surveys to include in these calculations, as well as the number of days to suppress recurring high- or low-threshold alerts. Similarly, a single-response threshold may be set (whether high or low) that provides a specific alert if even a single survey response falls above or below the specified threshold. Typically this would be used in connection with low thresholds only, where the target T has indicated such a low response that the system 10 would immediately send an alert 96 to the employee E (or service manager, etc.), such that the customer and issue can be immediately addressed by personnel before the customer leaves. In the example of FIG. 16, if the individual customer's response to the “promptness of greeting” question is at or below a two (out of five), an alert 96 is immediately sent to the employee E for use in taking immediate action. It is the content of this alert 96 that constitutes the action data provided to the employee E so that he or she may act accordingly.

It is further envisioned that the specific questions on the survey may be defined in one or more of the various sections of the control interface 60, such as in the control section 94. Further, and in the control section 94, the user may specifically identify the contact point or person that should receive the alert 96. Accordingly, and based upon the configurable rule set (threshold settings), the action data (or alert 96) may include communication data, contact data, employer data, employee data, satisfaction data, threshold data, analyzed data, improvement data, suggestion data, reinforcement data, a message, a text message, a predefined message, a configurable message, etc. This generated action data may be automatically and electronically communicated to a specified contact point based upon the application, and the contact information, e.g., cell phone number, e-mail address, etc., can be defined in the control interface 60, such as in the control section 94. This allows for the appropriate facilitation and communication between the necessary parties in reaction to the analyzed data. Also, and as discussed, the alert 96 or action data may be in the form of either a “negative” or “positive” alert 96.

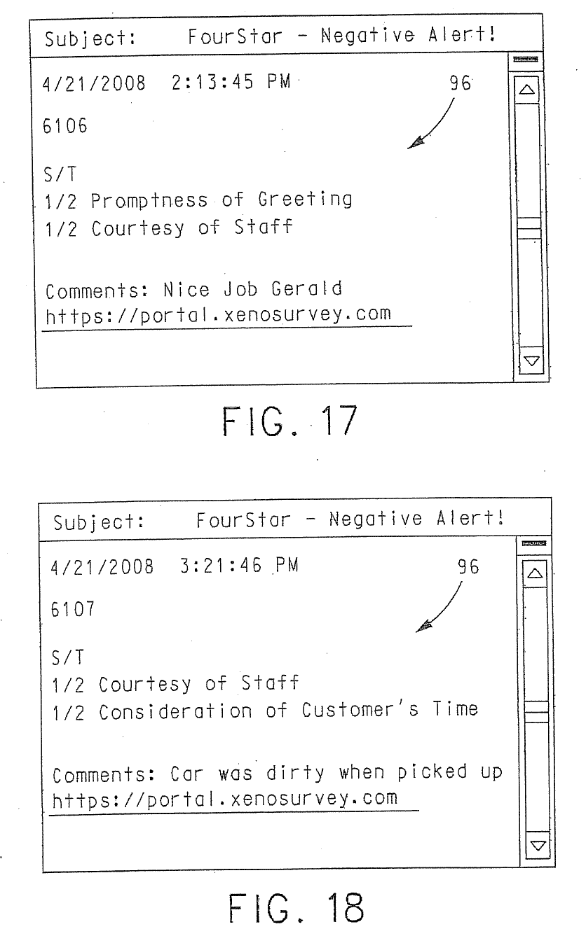

As illustrated in FIG. 17-20, these alerts 96 may be provided directly to the cellular telephones, personal digit assistants or similar handheld devices 58 of certain individuals, and these alerts 96 may include alpha-numeric text, such as performance percentages, numerical representations, or their textual equivalents. Such an alert 96 may be replied to by the user or used in subsequent communications in order to issue directives to the in-store location. In the example of FIGS. 17-20, the date and time the survey responses were submitted are displayed, as well as the repair order number (as entered by the employee E via the number pad 46 on the portable computing device 20). Both the score and threshold (at or below which an alert is generated) are displayed, as well as an identification as to which survey question the threshold was reached. In addition, and in these alerts 96 illustrated in FIGS. 17-20, the data provided in the handwritten input area 54 has been processed and translated, whether at the portable computing device 20, the central processing system 12 and/or the main processing system 30, and also provided to the employee E in the alert 96. Still further, a link to the portal or control interface 60 may also be provided. While normally these immediate and specific alerts are provided based upon the individually-defined thresholds, such alerts 96 may also be provided based upon the average scores over a set period of time or set amount of responses.

In one preferred and non-limiting embodiment, the survey is performed and implemented using proprietary software on the portable computing device 20 located at the in-store location. If the Internet connection is active, the collected survey data is sent to the off-site data storage analysis or central processing system 12. In particular, using certain computer-implemented instructions, the raw survey data may be stored and analyzed in real-time and the reports 88 generated, whether real-time reports or historical batch-type reports. With respect to the customer survey application being utilized at the in-store location, if the Internet is down, the survey data may be encrypted and cached. The Internet connection is periodically checked for connectivity, and once the Internet is again active, the data is sent as discussed above.

In one preferred and non-limiting embodiment, the control interface 60 is utilized in an ASP-based system, executed in an online environment, executed in a networked environment N, executed on a computing device 18, etc. For example, this control interface 60 may be remote from the on-site location, i.e., positioned in an off-site location, and would be in communication with the central processing system 12 and/or the main processing system 30. Further, this control interface 60 can be provided to various parties, whether at the in-store location or at an off-site location. Further, and as discussed, it is this control interface 60 that allows a user to provide predefined logic thresholds, input alert levels and reorganize, create or otherwise modify the survey questions and associated data.

Further, the specific reports 88 being generated as a result of the analysis of the survey data, and the various notifications or alerts 96 may be sent through the remote central processing system 12 and/or the main processing system 30 to the user's website, telephone, office, e-mail, etc. Further, these alerts 96 may be provided in real-time to the user, based upon server data that has been acquired, collected, processed and analyzed in a minimal amount of time. Still further, all the above-discussed transmissions and communications may be provided over a secure networked connection, such as a secure virtual private network tunnel, a secure HTTPS connection, etc.

In addition, the various reports, communications, transmissions, notifications, alerts 96, etc. may be provided in electronic form, e.g., wireless or wired communication, or even in paper form. Wireless networking technology may be used to provide a secure connection for storing the data from the surveys and processing payments, such as through the use of the magnetic strip reader/writer 40. It is also envisioned that a barcode scanner may be included on or in connection with the portable computing device 20 for use in reading barcodes to facilitate portable point-of-sale services, and also to provide price checks. Still further, inventory databases may be stored locally on the portable computing device 20 and synchronized to ensure accuracy and any implemented modifications.

In a further exemplary and non-limiting embodiment, the system 10, and in particular the portable computing device 20, would be capable of providing an incentive for the customer or target T to take the satisfaction survey by creating a gift card on the spot. One benefit of swiping the card on the magnetic strip reader/writer 40 on the portable computing device 20 would be the association of the target T and survey with that particular card, and to activate the gift card on the spot, thereby eliminating the possibility of pre-activated gift cards being given away or used inappropriately by theft or deception. When the gift card is used, the customer survey would be linked to the purchases to better qualify and understand the comments provided by the customer. Accordingly, still further demographic data could be obtained when the customer uses the gift card (or similar incentive).

In a further preferred and non-limiting embodiment, hybrid digital surveys are incorporated. In this embodiment, the survey content may support three methods of collection, including: (1) logical raw data stored digitally, based on numeric scores (ratings) or “yes/no” answers to the survey questions; (2) handwritten text or drawings captured from the handwritten input area 54 on the portable computing device 20 and stored digitally in raster format in the customer's own handwriting (which raster data could be analyzed to reveal key words and to better understand the customer); and (3) verbal responses to predefined questions captured digitally and analyzed to reveal the customer's state-of-mind, e.g., level of annoyance, contentedness, apathy, etc., in which audio file could then be converted to text and analyzed with the software to reveal key words that would help to provide a better understanding of the customer.

A further function would be the capability of providing portable point-of-sale/service payment processing. For example, a retailer that has a large outdoor or garden area could use this multi-function portable computing device 20 (such as the magnetic strip reader/writer 40) as a portable payment processing system at key spots during certain times of the day. Retailers could also associate these portable computing devices 20 in areas of anticipated high volume sales that generate excessive traffic, and would justify the addition of several portable payment processing systems to keep the customers moving and relieve congestion. A retailer that typically has “sidewalk sales” (seen in malls or outside large retail outlets) could station several portable computing devices 20 outside at the point of merchandise, as typically a sales person is nearby to monitor the merchandise in any case. These services not only provide better flow of sales for retailers, but also help to improve customer satisfaction by reducing wait times and improving quality of service. In addition, and in order to use such “roaming” pay stations, the consumer may be required to answer the survey questions.

In a further preferred and non-limiting embodiment, and as illustrated in schematic form in FIG. 21, the system 10 begins with data collection through the portable computing device 20, which serves as the data collection device for customer-conducted electronic surveys at customer locations. Each portable computing device 20 would be preconfigured or programmed with software in order to implement the system 10, and may use Cisco virtual private network (CVN) software, Microsoft Message Queue (MSMQ) services and other proprietary or known communication and similar services. The portable computing device 20 may also be configured to connect to a wireless router that supports secure Wireless High Fidelity (WiFi) connections. Both the portable computing device 20 and the wireless router that supports such communications are installed at the remote client locations. During hardware installation, the WiFi router is connected directly into the customer's existing Internet connection or local area network. The wireless connection between the portable computing device 20 and the WiFi router allows the portable computing device 20 to be placed up to 300 feet away from the wireless router and still maintain data connectivity. The WiFi router is used to transmit the survey data to the central processing system 12 and/or the main processing system 30.

In this embodiment, when the portable computing device 20 is first turned on, the system loads the Windows XP Professional operating system. After loading the operating system, the portable computing device 20 automatically connects to the WiFi router. The portable computing device 20 also launches the Cisco virtual private network (CVN) software with preconfigured connection settings designed to connect to the central processing system 12 and/or the main processing system 30. A Cisco virtual private network server is maintained at the central processing system 12 and/or main processing system 30 for receiving connections and communications from the portable computing device 20. The portable computing device 20 also automatically launches the appropriate application software, and to handle data transmissions between the portable computing device 20 and the central processing system 12, the portable computing device 20 may utilize message queuing through the MSMQ service technology. Message queuing may be used to handle asynchronous data transmission between the devices and systems.

Custom Microsoft window-based services may be used to launch and execute the appropriate software to manage the process. In this exemplary embodiment, users will see the client's location name in the top-left corner of the screen and a numeric keypad in the center of the screen. As discussed above, the employee E (or target T) enters the repair order number through the numeric keypad and provides the portable computing device 20 to customer to complete the survey process. As discussed above, the survey may be as long or as short as desired, and if multiple choice, may use a ratings scale, a numeric scale, a text description of levels, etc. All of these questions and the answers thereto may be customized based upon the employer's preferences.

Further, as discussed above, any known communication system, server hardware and other devices can be used to implement the method, process and system 10 of the present invention. FIG. 22 represents only one exemplary embodiment of such an implementation. Storage of data on the storage device 14, 32 (in one preferred and non-limiting embodiment) utilizes a Microsoft SQL Server in appropriate database format. Similarly, the Microsoft SQL Server may also maintain Microsoft SQL Server Reporting Services to generate web-based reporting for the website, or control interface 60. This control interface 60 may be stored and controlled through the Microsoft internet information services (IIS) web server, and use Secure Socket Layer (SSL) technology to secure and encrypt data that has passed between the client's browser and the web server. User name and password methodology for use in connection with the control interface 60 may be implemented in known processes. With appropriate permissions, web-enabled reports are also available, as discussed above in connection with the reports 88.

At first launch, the control interface 60 may open in its own window, and the user's security information passed to a back-end ASP.NET web service that obtains the client location associated with a particular user. Once the appropriate client location information is loaded, another request is sent through a web service to load all survey information for at least the first client location in the drop-down menu 50. Every five seconds, the control interface 60 sends a request through a web service to perform account of all information submitted for the selected location. If the count has increased since the last downloaded information, a new request will be sent through a web service to update all data.

As discussed above, one main feature of the present invention is the ability of the system 10 to evaluate incoming survey data against predefined criteria, and then provide alerts 96 to employees E of the result of the evaluation. Further, these thresholds may be single-response thresholds or multi-response thresholds, and may be adjusted via slider controls or similar control methods. Still further, these thresholds are completely customizable, and within the context of the present invention, should not be limited to simply low and high thresholds. For example, any number of thresholds may be defined in order to provide alerts 96 that include the appropriate action data or survey data to the appropriate personnel for engaging in a variety of activities.

The presently-invented method, process and system 10 overcome many of the various drawbacks and deficiencies discussed above in connection with the prior art methods and systems. By utilizing the combination of portable computing devices 20, wireless Internet services, VPN technology, together with the computer-implemented method, process and system 10 of the present invention, the system 10 can be effectively used at the point-of-sale/service. By using the digital ink features of Windows XP Tablet PC edition, handwritten comments may be captured in the survey application, and these raster graphics can then be parsed graphically to detect keywords. Customers are capable of browsing the Internet in a controlled fashion through a proprietary overlay that protects the user from pop-ups, malicious software, etc. The time the customer spends in each category, e.g., finance, travel, news, sports, etc. is tracked to create a “passive survey,” the results of which can provide useful information about the customer's interests. The survey application and system 10 of the present invention may be used to effectively capture data independent of Internet browsers, therefore being invulnerable to malicious software.

In one embodiment, if the Internet VPN connection is disrupted, the survey data is captured and stored in a specified and encrypted format on the local computing device, whether on the portable computing device 20, a local or on-site central processing system 12, etc. As soon as the Internet connection is restored, as may be automatically detected by the system 10, the cached data may be then transmitted to the data center or warehouse, i.e., the off-site central processing system 12 and/or main processing system 30. Accordingly, the survey process is not disrupted if the Internet connection is disrupted. By allowing the customer or target T to use the portable computing device 20 during the sales process, the customer's sales experience is enhance, while, at the same time, the system 10 passively captures additional data.

The interactive control interface 60 discussed above allows the survey questions to be easily modified, as well as the threshold levels for the alerts to be set. The configuration may be stored at some centralized location, e.g., the central processing system 12, the main processing system 30, etc., and any new configuration may be transmitted to the portable computing device 20 at the in-store location through a secure Internet connection. Further, the control interface 60 allows the surveyor or employee E to create rules based upon their own logic, and these rules are dynamically applied to the survey data in real-time.

Still further, the presently-invented method, process and system 10 provide an automatic alert system configurable by the employee E (or employer) at the control interface 60. This automatic alert system may be triggered by negative and/or positive thresholds, and may be preset based upon variables in the control panel. As discussed above, and as an example, if a negative threshold is crossed, e.g., “friendliness of sales staff” drops below 90% or a set number, an automatic alert 96 (e-mail and/or text message) may be sent to the appropriate people defined in the control interface 60, e.g., sales manager and principal, issuing a directive to effect change, e.g., “You must remind all sales staff to smile and be friendly to our customers!”, and also including the specific survey statistic. Further, the directive may indicate that the goal is 90% customer satisfaction for friendliness of sales staff, and the in-store location has dropped to 88.59%. At the same time, if a positive threshold is exceeded, e.g., “cleanliness of service department” rises above 95% or some set number, then a “good job” alert 96 may be sent to the appropriate personnel as defined by the control panel. An example of such a “positive” alert 96 is illustrated in FIG. 20.

In this manner, the presently-invented method, process and system 10 provides product- and service-based companies with improved customer loyalty and satisfaction. In one embodiment, by monitoring the customer satisfaction index or other survey data in real-time, and by having directives or action data issued automatically (also in real-time), customer satisfaction issues will be addressed more efficiently. Accordingly, by using certain embodiments of the present invention, businesses may operate more effectively, efficiently and save money and time.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of this disclosure. For example, it is to be understood that the present invention contemplates that, to the extent possible, one or more features of any embodiment can be combined with one or more features of any other embodiment.

What is claimed is:

1. A system for survey data acquisition and analysis, comprising:
at least one central processing system, including: (i) a storage device configured to obtain and store data; (ii) a processing device configured to process data; and (iii) a communication device configured to transmit or receive data; and
at least one portable computing device, including:
(i) a display device configured to visually display content to a user, the content comprising at least one survey question;
(ii) an input device configured to receive survey data input by the user in response to the at least one survey question;
(iii) a processing device configured to process the survey data input by the user; and
(iv) a communication device in communication with the communication device of the at least one central processing system and configured to transmit or receive data, wherein the communication device is further configured to transmit at least a portion of the survey data to the at least one central processing system;
wherein the processing device of the at least one central processing system processes survey data received from the at least one portable computing device.

2. The system of claim 1, wherein the survey data input by the user is in the form of at least one of the following: a selection from a plurality of responses, an alphanumeric response, a textual response, a handwritten response, a verbal response, identification data, user data, employer data, employee data, responsive data or any combination thereof.

3. The system of claim 1, wherein the at least one portable computing device is a tablet computer, and wherein the display device and the input device comprise a screen configured to permit interaction with a stylus.

4. The system of claim 1, wherein the communication device of the at least one portable computing device is configured to transmit the survey data to the at least one central processing system in at least one of the following: a substantially dynamic form, a real-time form, a batch form, periodically, contemporaneously, in a raw format, in a translated format, in an analyzed format or any combination thereof.

5. The system of claim 1, further comprising a configurable rule set, wherein at least a portion of the survey data input by the user is applied to the rule set, which generates action data based upon the application.

6. The system of claim 5, wherein the action data comprises at least one of the following: communication data, contact data, employer data, employee data, satisfaction data, threshold data, analyzed data, improvement data, suggestion data, reinforcement data, a message, a text messages, a predefined messages, a configurable message or any combination thereof.

7. The system of claim 5, wherein the generated action data is automatically and electronically communicated to a specified contact point based upon the application.

8. The system of claim 7, wherein the specified contact point is at least one of the following: an organization, a location, an employer, an employee, a user, a portable computing device, a personal computer, a cellular telephone, a personal digital assistant, a laptop computer, a palmtop computer, a notebook computer, a server, a tablet computer, a handheld device or any combination thereof.

9. The system of claim 1, wherein the survey data input by the user is in the form of a handwritten or verbal response, the processing device of the at least one central processing system configured to analyze the handwritten or verbal response and generate analytical data based thereon.

10. The system of claim 1, wherein the content displayed on the display device of the at least one portable computing device comprises selectively browsable web data.

11. The system of claim 10, wherein the web data displayed to the user on the display device is limited according to a predefined rule set.

12. The system of claim 10, wherein the user's interaction with the web data is tracked as user-specific navigation data.

13. The system of claim 1, wherein, based upon the user's interaction with the at least one portable computing device, the user is provided with at least one of the following: an incentive, a voucher, a coupon, an electronic incentive, a paper incentive, a certificate, a gift certificate, a discount or any combination thereof.

14. The system of claim 1, further comprising a plurality of portable computing devices, all in communication with the at least one central processing system, which is situated remote from at least one of the plurality of portable computing devices.

15. The system of claim 1, wherein the input device comprises at least one of the following: the display device, a microphone, a magnetic strip reader/writer, a camera, a keyboard or any combination thereof.

16. The system of claim 1, further comprising a main processing system remote from and in communication with at least one of the following: the at least one central processing system, the at least one portable computing device or any combination thereof, wherein the main processing system is configured to receive, process and transmit data.

17. A control interface for a survey data acquisition and analysis system, the control interface comprising at least one of the following:
an account management section configured to receive, process and display content representative of administration data;
a reporting section configured to receive, process and display content representative of at least one of the following: input data, employer data, employee data, identification data, survey data, communication data, contact data, satisfaction data, threshold data, analyzed data, improvement data, suggestion data, reinforcement data, textual data, graphical data or any combination thereof; and
a control section configured to receive, process, and display content representative of control data.

18. The control interface of claim 17, wherein in the account management section, a user is permitted to manage password data.

19. The control interface of claim 17, wherein in the reporting section, a user is permitted to: selectively view content, selectively print content in a specified format, selectively communicate content to specified other users or any combination thereof.

20. The control interface of claim 17, wherein in the control section, a user is permitted to: configure at least one threshold, configure at least one survey question, configure at least one alert, configure at least one rule, configure data or any combination thereof.

21. The control interface of claim 17, wherein the control interface is at least one of the following: an ASP-based system, executed in an online environment, executed in a networked environment, executed on a computing device or any combination thereof.

22. A system for survey data acquisition and analysis, comprising:
at least one portable computing device, including:
(i) a display device configured to visually display content to a user, the content comprising at least one survey question;
(ii) an input device configured to receive survey data input by the user in response to the at least one survey question;
(iii) a processing device configured to process the survey data input by the user; and
(iv) a communication device configured to transmit or receive data, wherein the communication device is further configured to transmit survey data; and
at least one central processing system in communication with the at least one portable computing system and configured to receive at least a portion of the survey data input by the user, wherein the at least one central processing system comprises a configurable rule set, and wherein at least a portion of the survey data input by the user is applied to the rule set, which generates action data based upon the application, and wherein the action data comprises at least one of the following: communication data, contact data, employer data, employee data, satisfaction data, threshold data, analyzed data, improvement data, suggestion data, reinforcement data, a message, a textual message, a predefined message, a configurable message or any combination thereof.

23. A system for survey data acquisition comprising at least one portable computing device, including:
(i) a display device configured to visually display content to a user, the content comprising at least one survey question;
(ii) an input device configured to receive survey data input by the user in response to the at least one survey question;
(iii) a processing device configured to process the survey data input by the user; and
(iv) a communication device configured to transmit or receive data, wherein the communication device is further configured to transmit at least a portion of the survey data.

24. A method of acquiring survey data from at least one user, the method comprising:
providing the user with at least one portable computing device at a retail establishment; and
obtaining survey data input by the user on the portable computing device.

25. The method of claim 24, further comprising:
analyzing the survey data input by the user; and
generating action data for use by a person affiliated with the retail establishment.

26. A method of acquiring and analyzing survey data, the method comprising:
providing the user with at least one portable computing device at a retail establishment;
obtaining survey data input by the user on the portable computing device;
analyzing the survey data input by the user;
generating action data for use by a specified person affiliated with the retail establishment; and
transmitting the action data to the specified person in a viewable format.
